(19) United States
(12) Patent Application Publication
(10) Pub. No.: US 2018/0079918 A1
(43) Pub. Date: Mar. 22, 2018

(54) METHODS OF PREPARING PAINTINGS

(71) Applicant: Chamber Works, LLC, Wilmington, DE (US)

(72) Inventor: Patrick Duffy, Kennett Square, PA (US)

(73) Assignee: Chamber Works, LLC, Wilmington, DE (US)

(21) Appl. No.: 15/706,035

(22) Filed: Sep. 15, 2017

Related U.S. Application Data
(63) Continuation of application No. 62/395,640, filed on Sep. 16, 2016.

(51) Int. Cl. C09D 7/12; C09K 11/06; C09K 11/02; C09D 5/22; C09D 5/06; B01J 13/08

(52) U.S. Cl. CPC C09D 7/1291; C09K 11/06; C09D 7/1275; C09K 2211/145; C09D 5/22; C09D 5/06; B01J 13/08; C09K 11/025

(57) ABSTRACT

Methods for preparing paintings containing an additional substance such as a substance selected from a nucleic acid, sand, soil, metal, cremated ash, ceramics, and plant tissue are described herein. The methods include applying paint comprising the additional subsance to a surface. The paintings may comprise an image that is visible under fluorescent light and contains that additional substance that is prepared by applying paint comprising the additional substance and at least one fluorescent compound to a surface to form the image. The additional substance and optionally the fluorescent compound may be encapsulated in a non-erodible polymer.

### RELATED APPLICATIONS

This application claims priority to U.S. Provisional Patent Application No. 62/395,640 filed on Sep. 16, 2016, the contents of which are incorporated herein in theft entirety.

### FIELD OF THE INVENTION

The present invention relates generally to methods of preparing paintings.

### BACKGROUND OF THE INVENTION

Paintings provide a method of memorializing a loved one such as a person or companion animal Methods are provided herein for enhancing the significance of a painting by creating a physical connection with the person or animal.

### SUMMARY OF THE INVENTION

Paintings comprising substances such as a biological material, sand, soil, metal, water, sea water, holy water, synthetic or biological polymers, cremated ash, ceramics, animal or plant tissue, or another physiologically compatible component having personal significance to an individual are described herein. These materials may be encapsulated, combined with paint, and used to create a painting.

In certain embodiments, the substance for incorporation into paint is selected from the group consisting of DNA, sand, soil, metal, cremated ash, ceramics, and plant tissue. In certain aspects, the invention relates to a method of preparing a painting comprising isolated DNA, the method comprising applying paint comprising isolated DNA to a surface.

In certain aspects, the invention relates to a method of preparing a painting comprising an image that is visible under fluorescent light and comprises isolated DNA, the method comprising applying paint comprising isolated DNA and at least one fluorescent compound to a surface to form the image.

In certain embodiments, the painting further comprises an image that is not visible under fluorescent light and does not comprise DNA. In certain embodiments, the DNA is fluorescently labeled. In certain embodiments, the fluorescent compound is a fluorescent bead. In certain embodiments, the DNA is encapsulated in a non-erodible, polymeric microparticle, wherein the microparticle comprises a hydrophobic, non-erodible polymer. In certain embodiments, the microparticle does not release the DNA. In certain embodiments, the fluorescent compound is encapsulated in a non-erodible, polymeric microparticle, wherein the microparticle comprises a hydrophobic, non-erodible polymer. In certain embodiments, the microparticle does not release the fluorescent compound.

In certain embodiments of the aforementioned methods, the polymer is selected from the group consisting of polyvinyl acetate, polyacrylate, polymethacrylate, and copolymers and blends thereof. In certain embodiments, the microparticle comprises less than 0.01% (w/w) DNA. In certain embodiments, the microparticle comprises at least 10% (wlw) of DNA. In certain embodiments, the microparticle has a size ranging from 1 micron to 1000 microns. In certain embodiments, the DNA comprises a personal identification characteristic selected from the group consisting of short tandem repeats (STRs), single nucleotide polymorphisms (SNPs), epigenetic markers, and methylated DNA patterns. In certain embodiments, the DNA is human DNA. In certain embodiments, the DNA is comprised within a particle that is at least 1 mm in diameter.

In certain embodiments of the aforementioned methods, the painting comprises an image of a human. In certain embodiments, the painting comprises an image of an animal. In certain embodiments, the paint is selected from the group consisting of latex paint, oil paint, synthetic paint, and watercolor paint. In certain embodiments, the DNA is not used for the purpose of multiplying or expressing the genetic information contained within it. In certain embodiments, the DNA is isolated from an organism. In certain embodiments, the DNA does not comprise a vector.

### DETAILED DESCRIPTION OF THE INVENTION

I. Definitions

The term “isolated DNA” as used herein refers to DNA that is purified from its source material, e.g. blood, hair, or tissue.

The term “non-erodible” as used herein means inert or unreactive after mixing with a paint and drying of the paint after application to a surface. The non-erodible polymers and the resulting polymeric microparticies described herein are able to withstand physical dissolution and/or chemical degradation processes that may occur in a paint, typically for at least 5 years, at least 10 years, at least 15 years, at least 20 years, or even longer following application of the paint to a surface.

As used herein, the term “hydrophobic polymer” refers to polymers that have a low affinity for water (at physiological temperature, e.g. 37° C.) and have a lower solubility in water than polylactic acid (PLA).

As used herein, the term “high molecular weight” means a molecular weight above 10,000 Daltons (Da), preferably above 20,000 Da.

As used herein, “nanoparticle” refers to a particle or a structure in the nanometer (nm) range, typically from about 1 to about 1000 nm in diameter.

As used herein, a “microparticle” is a particle of a relatively small size, but not necessarily in the micron size range; the term is used in reference to particles of sizes that can be, for example 1 to about 1000 microns. The term “microparticle” encompasses microspheres, microcapsules and microparticles, unless specified otherwise. A microparticle may be of composite construction and is not necessarily a pure substance; it may be spherical or any other shape.

As used herein, the term “percent loading” refers to a ratio of the weight of an encapsulated material (e.g. DNA or a fluorescent compound) to the weight of a microparticle, multiplied by 100.

As used herein, the term “small batch” refers to a batch size of an encapsulated material suitable for use by no more than one, no more than two, no more than three, no more than four, no more than five, no more than six, no more than seven, no more than eight, no more than nine, or no more than ten individuals, optionally with a small amount remaining after preparation of the paintings for verification purposes. In some embodiments, the batch size of the encapsulated material is less than about 10,000, 5000, 4000, 3000, 2000, 1000, 500, 100, 50, 10, 1, 0.1 or 0.01 mg. Any of these values may be used to define a range for the batch size of the encapsulated material. For example the batch size of the encapsulated material may range from about 10,000 mg to about 0.01 mg, from about 10,000 mg to about 1000 mg, or from about 5000 mg to about 500 mg.

II. Methods of Preparing Paintings

The use of compositions comprising paint and an additional substance for preparing paintings comprising the additional substance is described herein. Incorporation of the additional substance into the paint provides a method of memorializing a subject, for example, a person or animal, by preparing a painting comprising a substance isolated from a subject. In addition, incorporation of the substance into the painting enhances the significance of the painting by creating a physical connection with the person or animal. In certain embodiments, the painting comprises an image, for example, the image of a human, an animal, or a landscape. In a particular embodiment, the additional substance is DNA, for example, isolated DNA.

In certain embodiment, the painting comprises an image of a design, a figure, an animal, a still life, a landscape, nature, the sky, a part or aspect of any of these, a drawing, a collage, or a pattern. In certain embodiments the painting comprises a depiction or representation of a recognizable subject; a two-dimensional depiction or representation of a three-dimensional form; or a combination of these. In certain embodiments, the painting is figurative, realistic, representational, abstract, surrealistic, a landscape or a still life. In certain embodiments, the painting has subject matter that is realistic, representational or abstract; it shows fireworks, stars, the sky, skylight, natural light, sunset or sunrise; it shows light emitted in gradations; it has one or more other effects of light; or it has a combination of these. In some embodiments the work has a visible aesthetic effect or design resembling that in a known conventional work of art or design, resembling that in a known kind of art or design; or resembling that in an image by Rembrandt van Rijn, Vermeer, a Dutch Old Master, Turner, Van Gogh, Monet, Seurat, an Impressionist artist, Jackson Pollock, Marc Rothko, Brancusi, Noguchi, Tiffany, I.M. Pei or another well-established image-maker; or it is a combination of these. In some embodiments, the painting contains a photographic image, a colorant; a conventional image making medium, a conventional artist's medium, a primer conventionally used to make images or an underlayer; development from the use of a conventional image-making process; or it has an imprimatura, a ground and/or collage. In some embodiments, the painting comprises metal, fabric, paper, wood, clay, ceramic, a gem, or a stone; or a combination of these. In some embodiments, the painting is an image-making medium or work that has at least one aesthetic property, for example, from an additive or subtractive process, a conventional image-making process, a conventional image making medium, a conventional artist's medium or a conventional artist's painting or drawing medium.

In certain aspects the present invention relates to a method of preparing a painting comprising an additional substance (e.g. DNA), the method comprising applying paint comprising the additional substance to a surface. For example, in some aspects, the invention relates to a method of preparing a painting comprising an image that is visible under fluorescent light and comprises an additional substance (e.g. DNA), the method comprising applying paint comprising the additional substance and at least one fluorescent compound to a surface to form the image. Incorporation of a fluorescent compound into the paint comprising the additional substance enables visualization of the image formed by the paint comprising the additional substance, for example, by exposing the painting to fluorescent light. In some embodiments, the painting comprises a first image that comprises the additional substance (e.g. DNA) and is visible under fluorescent light, as described above, and a second image that does not comprise the additional substance (e.g. DNA) and is not visible under fluorescent light. For example, the painting may be prepared by first applying paint comprising the additional substance and a fluorescent compound to a surface, and then applying the second image that is not visible under fluorescent light and does not comprise the additional substance over the first image. In other embodiments, paint that does not comprise the additional substance (e.g. DNA) or a fluorescent compound is first applied to the surface to form an image, and then paint comprising the additional substance (e.g. DNA) and a fluorescent compound is applied over this image. In further embodiments, particular sections of the painting may be prepared with paint comprising the additional substance (e.g. DNA) and a fluorescent compound, while other sections may be prepared with paint that does not comprise the additional substance or a fluorescent compound. In certain embodiments, the additional substance (e.g. DNA) is labeled with the fluorescent compound, for example, by covalent attachment of the fluorescent compound to the additional substance (e.g. DNA).

The additional substance (e.g. DNA) and/or the fluorescent compound may be encapsulated in microparticles. After the painting is prepared, the encapsulated material remains in the microparticles, and the microparticles do not erode. Accordingly, encapsulation of the additional substance (e.g. DNA) and/or the fluorescent compound in microparticles prevents diffusion of these compounds through the paint, thus maintaining the integrity of the image visible under fluorescent light. A simple in vitro test can be used to confirm that the microparticles will not release the encapsulated material into the paint. For example, after formation of microparticles containing the additional substance (e.g. DNA) and/or a fluorescent compound, the microparticles can be mixed with the paint and stored at room temperature for at least about 1 month. Samples are removed periodically, such as after 1 hour, after 1 day, after 1 week, and after 1 month, the microparticles are separated from the paint (for example, by centrifugation), and the paint is analyzed using a suitable detection method to determine if any traces of the encapsulated material (i.e. the additional substance or fluorescent compound) are in the paint.

Nonlimiting examples of suitable fluorescent compounds include: fluorescent organic dyes such as xanthenes (e.g., fluoresceins, rhodamines, etc.), cyanines, luminescent groups (e.g.lanthanides, chelates, ruthenium, etc.), coumarins, pyrenes, bodipy dyes, and FLAsh; non-organic chromophores such as semiconductor nanocrystals (quantum dots), silicon, gold, and metal nanoparticles; intercalator dyes such as DAPI, DRAQ-5, and Hoechst 33342; and expressible fluorescent proteins such as Green Fluorescent Protein (GFP), yellow fluorescent protein, and red fluorescent protein. In certain embodiments, the fluorescent compound is a fluorescent bead.

Suitable paints include latex paints (e.g. acrylic, vinyl acrylic (PVA), and styrene acrylic paints), oil paints, synthetic paints, and watercolors. Different colors of paint may be used to prepare the painting. In some embodiments, the painting comprises at least 2, 3, 4, 5, 6, 7, 8, 9 or 10 different colors of paint.

Suitable detection methods for DNA and fluorescent compounds are known in the art. For example, suitable methods for detection of whether any DNA is released include detection of the fluorescence of labeled DNA released into the paint and/or PCR amplification of a sample of the paint. PCR methods for detecting low levels of DNA in a sample are known in the art. See, for example, Sambrook, et al., Molecular Cloning. (4th ed.). Cold Spring Harbor, N.Y.: Cold Spring Harbor Laboratory. Conventional PCR and real-time PCR with real-time monitoring of amplification may be used to detect any DNA release. The PCR amplification may use the same primers and amplification conditions as those used for amplification of DNA prior to encapsulation. The PCR amplification may follow up to 50 amplification cycles and generates a detectable number of amplified DNA molecules, if any DNA is present in the paint, referred to as “the amplified product”). Following PCR, the amplified product, if present, may be detected by conventional gel electrophoresis techniques or UV-Vis spectrometry for detecting double-stranded DNA. See, for example, Sambrook, et al., Molecular Cloning. (4th ed,), Cold Spring Harbor, N.Y.: Cold Spring Harbor Laboratory. Presence of an amplified product following the process described above indicates release of DNA from the microparticles, and absence of amplified product indicates that DNA was not released from the microparticles. The fluorescent compound may also be detected by detecting fluorescence of a sample of the paint.

For compositions with non-DNA material(s) as the encapsulated additional substance, mass spectrometry may be used as the detection method following an in vitro assay as described above.

As used herein the term “a microparticle that does not release the encapsulated material” refers to a microparticle that does not release a substantial amount of the encapsulated material (e.g. DNA) in the paint as detected by an in vitro assay as described above. In some embodiments, the microparticle does not release a detectable amount of the encapsulated material (e.g. DNA) after 1 hour, 1 day, 1 week, 2 weeks, 3 weeks, 1 month, 6 months, 1 year, 5 years, 10 years, 20 years, or 30 years as determined by an in vitro assay as described above. In some embodiments, the microparticle releases less than 10%, 5%, 1%, 0.5%, 0.1%, 0.05%, 0.01%, 0.005% or 0.001% of the total amount of the encapsulated material contained in the microparticle. In some embodiments, the microparticle releases less than 10%, 5%, 1%, 0.5%, 0.1%, 0.05%, 0.01%, 0.005% or 0.001% of the total amount of the encapsulated material contained in the microparticle after 1 hour, 1 day, 1 week, 2 weeks, 3 weeks, 1 month, 6 months, 1 year, 5 years, 10 years, 20 years, or 30 years. In a particular embodiment, the microparticle releases less than 0.1% of the total amount of the encapsulated material (e.g. DNA and/or a fluorescent compound) contained in the microparticle after 2 weeks.

For compositions with DNA as the encapsulated material, the detection method following an in vitro assay as described above includes amplification by PCR followed by detection by conventional gel electrophoresis techniques or UV-Vis spectrometry. For compositions with the fluorescent compound as the encapsulated material, detection of fluorescence of the paint sample may be used as the detection method as described above.

In a particular embodiment, the microparticle does not comprise pores that are visible using scanning electron microscopy (SEM). In a particular embodiment, the microparticle does not comprise silica. In a particular embodiment, the encapsulated additional substance (e.g. DNA) is in direct contact with the encapsulating polymer. In a particular embodiment, the microparticle does not comprise an additional encapsulating material between the additional substance and the encapsulating polymer.

1. Personalizing Substance

Generally, the compositions described herein include a personalizing substance. Suitable personalizing substances include, but are not limited to, biological materials such as, for example, animal or plant tissue, sand, soil, metal, sea water, holy water, synthetic or natural polymers, cremated ash, ceramics, and other physiologically compatible components. In the case of liquid personalizing substances such as sea water and holy water, lyophilization of microparticles comprising the personalizing substance would remove any liquid contained in the microparticle. However, any salts or other non-volatile compounds contained in the liquid would remain.

In some embodiments, the compositions may contain encapsulated DNA without any additional personalizing substances. In other embodiments, the compositions contain a personalizing substance comprising DNA and one or more additional personalizing substances comprising other compounds. For example, the additional personalizing substances may be one or more samples from sand, soil, metal, ceramics, and/or plant products.

Exemplary Additional Substances

Suitable additional substances for incorporation into paint include, but are not limited to, sand, soil or rock particles, or compounds extracted from sand, soil or rock.

Sand consists predominately of silica (SiO₂) and other organic and inorganic minerals, such as calcium silicate (Ca₂SiO₄), calcium nitride (Ca₃N₂), silicon nitride (Si₃N₄), aluminum nitride (AIN₃), alumina (Al₂O₃), borazone “boron nitride” (BN), magnesium oxide (MgO), silicon oxysulfide (SiOS), lithium silicate (Li₂SiO₄), as well as other metal oxides/nitrides, as shown in Table 1.

The identity of additional substances that do not contain DNA, such as sand, soil, metal, water, sea water, holy water, synthetic or natural polymers, cremated ash, ceramics, and compounds derived from plants, may be confirmed by a suitable method, such as mass spectrometry, for example, isotope-ratio mass spectrometry (IRMS) or liquid chromatography mass spectrometry (LC-MS).

TABLE 1
Exemplary Additional Substances

| Source for | |
|---|---|
| Additional | |
| Substance | Additional Substance |
| White Beach | Quartz (SiO₂) particles of different diameter ranges |
| Sand | and limestone from coral or shells. |
| Dark Sand | Quartz (SiO₂) particles of different diameter ranges |
| | and magnetite % |
| Green Sand | Quartz (SiO₂) particles of different diameter ranges |
| | and chlorite |
| Rock | Quartz (SiO₂) particles of different diameter ranges |
| | and other trace elements that vary with geographical |
| | location. |

For example, the additional substance may contain silicon dioxide particles extracted from a soil or rock sample. Suitable extraction techniques are known. Following extraction, the particles may be ground by conventional means to reduce their size to less than 1 micron, optionally the particles are then screened to obtain a population of particles having a size range for encapsulation, or micronized to produce nanoparticles of suitable size, typically from about 1 to about 1000 nm in diameter. Optionally, the particles may be mixed with paint after encapsulation.

In some embodiments, the additional substance comprises particles of a metal or ceramic object having meaning to a person receiving the substance. For example, such metal or ceramic objects can be ground, screened and extracted to remove unwanted components, encapsulated, and mixed with paint for preparation of a painting.

In some embodiments, the additional substance includes extracts of wooden items that have personal meaning to the individual. For example, in some embodiments cellulose is extracted from the wood item and encapsulated and mixed with paint for preparation of a painting.

The additional substance may be added as a solid or in the form of a liquid, such as in the form of an emulsion, to the microparticle forming material. Following encapsulation, the additinoal substance is in the form of small particles, typically nanoparticles, in the microparticle. Generally, the additional substance is in the core of the microparticles and is surrounded by the hydrophobic, non-erodible polymeric matrix, i.e, the shell. The encapsulated additional substance has a size smaller than the resulting microparticles, and may be smaller than 1 micron in diameter (or in its largest dimension for non-spherical particles).

DNA

The DNA used to prepare the painting is intended to remain inert. Accordingly, in some embodiments, the DNA does not comprise a vector. As used herein the term “vector” refers to a DNA molecule used in biotechnology for storage, propagation, delivery or integration of recombinant DNA. Examples of vectors include plasmid backbones, viral vectors, bacmids, cosmids, and artificial chromosomes.

Generally, the vector itself is a DNA sequence that consists of an insert (transgene, or recombinant DNA) and a larger sequence that serves as the “backbone” of the vector. The purpose of a vector is to transfer the insert to another cell, where it may be isolated, multiplied, or expressed. In some embodiments, the DNA does not comprise DNA that is used to transfer a DNA sequence into a cell. In some embodiments, the DNA does not comprise DNA used for the purpose of multiplying or expressing the genetic information contained within it.

Optionally, the DNA includes one or more personal identification characteristics. The one or more personal identification characteristics contain unique information which can be used to verify that the DNA was obtained from a particular source, e,g., a human, non-human animal, or plant. A verification step may be made prior to or subsequent to encapsulation of the DNA or incorporation of the DNA into the paint.

Exemplary personal identification characteristics for DNA include, but are not limited to, microsatellite markers such as short tandem repeats (STRs) and Simple Sequence Repeat (SSR) markers, single nucleotide polymorphisms (SNPs), and epigenetic markers, such as methylated DNA patterns. Any DNA sequence that is unique to the source organism may be used as a personal identification characteristic. For example the DNA sequence unique to the source organism may be identified by sequencing the entire sequence of the DNA isolated from the source organism, or a portion thereof, using sequencing methods known in the art such as Sanger sequencing or next generation sequencing, e.g. Illumina sequencing, DNA sequencing methods are well known in the art and are described, for example, in Sambrook, et al., Molecular Cloning. (4th ed.), Cold Spring Harbor, N.Y.: Cold Spring Harbor Laboratory.

a. Polymorphic Genetic Markers

DNA generally includes one or more polymorphic genetic markers. Polymorphic genetic markers are highly variable regions of the genorne which have contributed to the development of a variety of applications such as forensic DNA analysis and paternity testing that are used to unambiguously identify individuals.

The identification of many polymorphic genetic markers has occurred over the last thirty years. For example, polymorphic genetic markers known as variable number of tandem repeats (VNTRs) are abundant and highly polymorphic regions of DNA containing nearly identical sequences, 14 to 80 bases in length, repeated in tandem. See Jeffreys et al., 1985, Nature 314: 67-73; Wyman et al., 1980, PNAS 77: 6754-6758; and Nakamura et al., 1987, Science 235: 1616-1622. The variation in these markers between individuals makes them useful for identifying particular individuals. VNTRs may be detected from small amounts of DNA using polymerase chain reaction (PCR). See Kasai et al., 1990, Journal of Forensic Sciences 35(5): 1196-1200. Size differences in the amplified PCR products are detected on agarose or polyacrylamide gels. However, the finite number of VNTRs limits the widespread applicability of this method, which in turn led to the identification of short tandem repeats (STR).

b. Short Tandem Repeats (STR) STRs can be amplified by a polymerase chain reaction, and are highly abundant and polymorphic (variable from individual to individual). STRs can contain tandem repeat sequences that differ by two (dinucleotide), three (trinucleotide), four (tetranucleotide) or five (pentanucleotide) base pairs. It is estimated that there are approximately 50,000 to 100,000 dinucleotide repeats in the human genome. Trinucleotide and tetranucleotide repeats are less common; the human genome is estimated to contain 10,000 of each type of repeat. See Tautz et al, 1989, Nuc, Acids Res. 17: 6464-6471; and Hamada et al., 1982, PNAS 79: 6465-6469. The use of tetranucleotide and pentanucleotide STRs allows better discrimination of differences between individual subjects relative to the shorter sequences. See Weber et al., 1989, Am J Hum Genet 44: 388-396.

The DNA may contain a human DNA sequence selected from the group consisting of a dinucleotide STR, a trinucleotide STR, a tetranucleotide STR and a pentanucleotide STR.

Because the size of PCR products from human tetranucleotide repeat regions typically varies between individuals, DNA comprising tetranucleotide repeats are preferred for use in the methods described herein. For example, PCR products of two different sizes are observed based on the inheritance for each individual of one copy of the polymorphic marker from each parent. Each inherited copy contains a variable number of tetranucleotide repeats. Thus, two unrelated individuals likely will produce different sized PCR products from the same tetranucleotide polymorphic marker. As a greater number of different tetranucleotide repeat regions are compared between individuals, the probability of those individuals sharing the identical pattern of PCR products decreases.

c. Single Nucleotide Polymorphisms (SNPs)

Single nucleotide polymorphism is a DNA sequence variation occurring commonly io within a population (e.g. 1%) in which a single nucleotide—A, T, C or G—in the genome (or other shared sequence) differs between members of a biological species or paired chromosomes. For example, two sequenced DNA fragments from different individuals, AAGCCTA to AAGCTTA, contain a difference in a single nucleotide.

SNPs may fall within coding sequences of genes, non-coding regions of genes, or in the intergenic regions (regions between genes). SNPs within a coding sequence do not necessarily change the amino acid sequence of the protein that is produced, due to degeneracy of the genetic code.

SNPs in the coding region are of two types, synonymous and nonsynonymous SNPs, Synonymous SNPs do not affect the protein sequence while nonsynonymous SNPs change the amino acid sequence of protein. The nonsynonymous SNPs are of two types: missense and nonsense.

SNPs that are not in protein-coding regions may still affect gene splicing, transcription factor binding, messenger RNA degradation, or the sequence of non-coding RNA. Gene expression affected by this type of SNP is referred to as an eSNP (expression SNP) and may be upstream or downstream from the gene.

SNPs without an observable impact on the phenotype (so called silent mutations) are still useful as genetic markers in genome-wide association studies, because of their quantity and the stable inheritance over generations.

Nanoparticles

Optionally, the additional substance (e.g. DNA) is formed into or encapsulated in nanoparticles prior to encapsulation in the polymeric microparticles.

The additional substance (e.g. DNA) may be micronized to produce nanoparticles of suitable size,

In some embodiments the nanoparticle comprises or consists of DNA from a human or from a companion animal, The DNA may be precipitated by calcium phosphate. In certain embodiments the DNA is formed by micronizing the DNA to reduce its size, in preparation for microencapsulation.

The diameter of the nanoparticle may be, for example, about 1000, 900, 800, 700, 600, 500, 400, 300, 200, 100, 90, 80, 70, 60, 50, 40, 30 or 20 nanometers (nm). In certain embodiments, the diameter of the nanoparticle is less than about 1000, 900, 800, 700, 600, 500, 400, 300, 200, 100, 90, 80, 70, 60, 50, 40, or 30 nanometers (nm). Any of these values may be used to define a range for the diameter of the nanoparticle. For example, the diameter of the nanoparticle may be from about 20 nm to about 1000 nm or from about 20 nm to about 100 nm.

Polymeric Microparticles

The additional substance (e.g. DNA) and/or fluorescent compound may be encapsulated in a polymeric microparticle. The core of the microparticles contains the encapsulated material, which is surrounded by a polymeric matrix that forms the outer shell of the microparticles.

Optionally, the additional substance (e.g. DNA) is formed into nanoparticles, which are encapsulated in the polymeric microparticle. In some embodiments, the encapsulated material is a DNA nanoparticle which is prepared by calcium phosphate precipitation.

The calcium phosphate precipitated DNA nanoparticle may be encapsulated in a polymeric microparticle without dissolving the DNA in a solvent.

In some embodiments, the microparticle comprises both the additional substance (e.g. DNA) and a fluorescent compound. Fluorescent compound particles in the polymeric microparticles are generally smaller than 100 nm and preferably smaller than 20 nm. In some embodiments, the microparticle comprising the additional substance (e.g. DNA) does not include a fluorescent compound. In some embodiments, the microparticle comprising the additional substance does not contain a pigment or dye.

Any polymer that is non-erodible may be used to form the microparticles. Suitable polymers include, but are not limited to: polyamides, polycarbonates, polyalkylenes, polyalkylene glycols, polyalkylene oxides, polyalkylene terephthalates, polyvinyl alcohols, polyvinyl ethers, polyvinyl esters, polyvinyl halides, polyvinylpyrrolidone, polyglycolides, polysiloxanes, polyurethanes and copolymers thereof, alkyl cellulose, hydroxyalkyl celluloses, cellulose ethers, cellulose esters, nitro celluloses, polymers of acrylic and methacrylic esters, methyl cellulose, ethyl cellulose, hydroxypropyl cellulose, hydroxy-propyl methyl cellulose, hydroxybutyl methyl cellulose, cellulose acetate, cellulose propionate, cellulose acetate butyrate, cellulose acetate phthalate, carboxylethyl cellulose, cellulose triacetate, cellulose sulphate sodium salt, poly(methyl methacrylate), poly(ethylmethacrylate), poly(butylmethacrylate), poly(isobutylmethacrylate), poly(hexylmethacrylate), poly(isodecylmethacrylate), poly(lauryl methacrylate), poly(phenylmethacrylate), poly(methyl acrylate), poly(isopropyl acrylate), poly(isobutylacrylate), poly(octadecyl acrylate), polyethylene, polypropylene poly(ethylene glycol), poly(ethylene oxide), poly(ethylene terephthalate), poly(vinyl alcohols), poly(vinyl acetate), poly vinyl chloride polystyrene and polyvinylpryrrolidone.

Examples of non-biodegradable polymers include ethylene vinyl acetate, poly(meth)acrylic acid, polyamides, copolymers and mixtures thereof. Example of biodegradable polymers include synthetic polymers such as polymers of lactic acid and glycolic acid, polyanhydrides, poly(ortho)esters, polyurethanes, poly(butic acid), poly(valeric acid), poly(caprolactone), poly(hydroxybutyrate), poly(lactide-co-glycolide) and poly(lactide-co-caprolactone), and natural polymers such as alginate and other polysaccharides including dextran and cellulose, collagen, chemical derivatives thereof (substitutions, additions of chemical groups, for example, alkyl, alkylene, hydroxylations, oxidations, and other modifications routinely made by those skilled in the art), albumin and other hydrophilic proteins, zein and other prolamines and hydrophobic proteins, copolymers and mixtures thereof. In general, these materials degrade either by enzymatic hydrolysis or exposure to water in vivo, by surface or bulk erosion. These may be used alone, as physical mixtures (blends), or as co-polymers.

In certain embodiments, the composition and molecular weight of the polymers that form the microparticles are such that the glass transition temperature of the polymers is greater than or equal to 60° C. or the melting point of the polymers is greater than or equal to 50° C. In certain embodiments, the glass transition temperature of the polymers is greater than or equal to about 60, 61, 62, 63, 64, 65, 66, 67, 68, 69, 70, 75, or 80° C. In certain embodiments, the melting point of the polymers is greater than or equal to about 50, 51, 52, 53, 54, 55, 56, 57, 58, 59, 60, 65 or 70° C. Polymers with a high glass transition temperature, i.e. a glass transition temperature that is greater than or equal to 60° C., or high melting point, i.e. a melting point that is greater than or equal to 50° C., include, but are not limited to, poly (methyl methacrylate) (PMMA), polystyrene, polyethylene terephthalate, and polycarbonate. In a particular embodiment, the polymer is selected from the group consisting of polyvinyl acetate, polyacrylates, polymethacrylates, and copolymers and blends thereof. In another particular embodiment, the polymer is selected from the group consisting of polyacrylates, polymethacrylates, and copolymers and blends thereof. If the microparticle is formed from a copolymer or blend of polymers, the copolymer or blend may be formed from polymers with a high glass transition temperature or high melting point, and may not contain any polymer with a low glass transition temperature, i.e. a glass transition temperature lower than 60° C., or a melting point that is lower than 50° C.

Suitable polymers with a glass transition temperature greater than or equal to 60° C. or suitable polymers with a melting point greater than or equal to 50° C. include, but are not limited to, polyacrylates, polymethacrylates, polycarbonates, polypropylenes, polyalkylenes, polyalkylene glycols, polyalkylene oxides, polyalkylene terephthalates, polyvinyl ethers, polyvinyl halides, polysiloxanes, polyurethanes and copolymers thereof, hydroxyalkyl celluloses, cellulose ethers, nitro celluloses, methyl cellulose, ethyl cellulose, cellulose acetate, cellulose propionate, cellulose acetate butyrate, cellulose triacetate, cellulose sulphate sodium salt, poly(methyl methacrylate), poly(ethylmethacrylate), poly(butylmethacrylate), poly(isobutylmethacrylate), poly(hexylmethacrylate), poly(isodecylmethacrylate), poly(lauryl methacrylate), poly(phenylmethacrylate), poly(methyl acrylate), poly(isopropyl acrylate), poly(isobutylacrylate), poly(octadecyl acrylate), polyethylene, polyethylene terephthalatepoly(vinyl acetate), and poly vinyl chloride polystyrene, and mixtures, copolymers, and blends thereof.

Preferred polymers include polyacrylates and polymethacrylates.

In certain embodiments, the polymethacrylate is poly(methyl methacrylate) (PMMA). Medical grade PMMA (MW=35 kDa; residual MMA monomer<0.1%) is commercially available from Vista Optics Ltd. (Widnes, UK).

The microparticles can have any shape. Typically the microparticles are spherical. Other suitable shapes include, but are not limited to, flakes, triangles, ovals, rods, polygons, needles, tubes, cubes and cuboid structures.

In certain embodiments, the microparticles have a diameter of less than 10, 9, 8, 7, 6, 5, 4, 3, 2, 1, 0.9, 0.8, 0.7, 0.6, 0.5, 0.4, 0.3, 0,2 or 0.1 micron(s). Any of these values may be used to define a range for the diameter of the microparticle. For example the diameter of the microparticle may be from about 0.1 to about 10 microns, from about 0.1 to about 1 micron, or from about 0.1 to about 2 microns. Typically, the microparticle diameter is less than 5 microns. In some embodiments, the microparticle diameter ranges from about 1 to about 10 microns, more preferably from about 1 to 2 microns.

In other embodiments, larger microparticles or particles may be used. For example the microparticles may have a diameter of ranging from 10 microns to 1000 microns (1 mm). In some embodiments, the particle comprising DNA and/or a fluorescent compound has a diameter from 1 mm to 5 mm, for example, from 2 mm to 5 mm. Particles that are 1 mm in diameter or greater may be detected in the painting visually or by touch.

Typically, the concentration of an encapsulated material in a microparticle is presented as percent loading. Because values for the percent loading are dependent on the weights of the encapsulated materials, percent loading values for different encapsulated materials may vary significantly. Therefore, different ranges for the percent loading for different encapsulated materials are contemplated.

In some embodiments, low concentrations (e.g., up to 0.1% w/w or lower) of the encapsulated material in the microparticles may be used to prevent leaching of the encapsulated material from the microparticle.

In some embodiments, such as when the encapsulated material is DNA, only a small sample is provided for encapsulation. In these embodiments, the microparticles typically contain low concentrations of DNA. However, if a large amount of the encapsulated material is provided, the loading of the encapsulated material in the microparticle can be higher as long as the resulting microparticles do not allow DNA to be released.

In some embodiments, the microparticle comprises about 0.00001, 0.00005, 0.0001, 0.0005, 0.001, 0.005, 0.01, 0.02, 0.03, 0.04, 0.05, 0.06, 0.07, 0.08, 0.09, 0.1, 0.5, 1, 2, 3, 4, 5, 6, 7, 8, 9, 10, 20, 30, 40 or 50% by weight of the encapsulated material (e.g. DNA)/weight of the microparticle (w/w). In some embodiments, the microparticles comprise less than about 0.00001, 0.00005, 0.0001, 0.0005, 0.001, 0.005, 0.01, 0.02, 0.03, 0.04, 0.05, 0.06, 0.07, 0.08, 0.09, 0.1, 0.5, 1, 2, 3, 4, 5, 6, 7, 8, 9, 10, 20, 30, 40 or 50% by weight of the encapsulated material (e.g. DNA)/weight of the microparticle (w/w). In some embodiments, the microparticles comprise at least about 0.00001, 0.00005, 0.0001, 0.0005, 0.001, 0.005, 0.01, 0.02, 0.03, 0.04, 0.05, 0.06, 0.07, 0.08, 0.09, 0.1, 0.5, 1, 2, 3, 4, 5, 6, 7, 8, 9, 10, 20, 30, 40 or 50% by weight of the encapsulated material (e.g. DNA)/weight of the microparticle (w/w). Any of these values may be used to define a range for the concentration of the encapsulated material in the microparticle. For example, the microparticles may contain encapsulated material in an amount ranging from about 0.00001 to about 50% w/w or from about 0.001 to about 2% w/w. In some embodiments, the amount of encapsulated material in the microparticles is less than about 0.1% w/w.

Typically, percent loading for the additional substance (e.g. DNA) in the microparticles ranges from 0,000001% to 0.1% weight of the additional substance to the total weight of the microparticles (% w/w). In some embodiments, the amount of the amount of the additional substance (e.g, DNA) in the microparticles is less than 0.01% (w/w), for example, from 0.001% to 0.00001% (w/w). These loading ranges are generally applicable to single-walled microparticles.

However, for embodiments, in which the microparticles are double walled microparticles, higher loadings of the additional substance (e.g. DNA) may be used. It is expected that the structure of the double-walled microparticles protects the additional substance (e.g. DNA) from leaching out of the microparticles. In these embodiments, the amount of the additional substance (e.g. DNA) in the microparticles may range from 0.000001% to about 5% weight of the additional substance to the total weight of the microparticles (% w/w), optionally from about 1%-5% (w/w)

III. Exemplary Paints Containing an Additional Substance

In certain embodiments, the additional substance mixed with the paint is DNA from a human, a non-human animal (e,g. a pet), or a plant,

In a particular embodiment, the DNA is from a human. No two people have the exact same sequence of DNA in their cells. The differences in the DNA in individual humans gives rise to the unique DNA profiles that can be used to distinguish individuals. In addition, the unique DNA profile of each individual provides a means for verifying that the DNA is from a particular individual. Accordingly, incorporation of DNA into paint provides a unique characteristic to the paint that may be verified, for example, through DNA sequencing or analysis of genetic markers.

The DNA may be coding or non-coding genomic DNA, coding or non-coding mitochondrial DNA or complementary DNA (cDNA). cDNA is synthesized from RNA using reverse transcriptase. The genomic DNA, mitochondrial DNA, and RNA for synthesis of cDNA may be isolated from any organism, including but not limited to humans, animals, and plants. In some embodiments, the DNA is isolated from a single organism, for example, a human. In other embodiments, the DNA is isolated from two or more organisms, for example, two or more humans. Methods of isolating genomic DNA, mitochondrial DNA and RNA, and methods of cDNA synthesis are well known in the art and are described, for example, in Sambrook, et al., Molecular Cloning. (4th ed.). Cold Spring Harbor, N.Y.: Cold Spring Harbor Laboratory.

In some embodiments, the DNA mixed with the paint is isolated directly from an organism, such as genomic DNA or mitochondrial DNA. In other embodiments, the DNA mixed with the paint is amplified from a sample collected from the organism, for example by polymerase chain reaction (PCR). Multiple DNA segments for is tetranucleotide PCR amplification typically may be amplified in a single tube. Such multiple amplification of several DNA regions is known in the art as multiplex PCR. The multiple PCR products are separated as known in the art, for example, by electrophoresis, and an instrument reads the electrophoresis gel or image to automatically analyze the sizes of the PCR products. In some embodiments, the DNA is cDNA reverse transcribed from RNA isolated from the organism, as mentioned above.

The DNA may be sequenced so that verification steps described below may be performed. (Sambrook, et al., Molecular Cloning. (4th ed.). Cold Spring Harbor, N.Y.: Cold Spring Harbor Laboratory).

Preparation of DNA samples may proceed as follows, although other methods of preparing analogous DNA samples are known to the skilled artisan. One preferred method includes the following general steps:

A sample for preparation of the DNA is collected from a sample of cheek swab, skin, hair, saliva, or blood or other tissue from an organism as is known in the art. A cheek swab sample is preferred. Protocols for collecting and handling the sample are known in the art.

For example, a DNA isolation kit suitable for isolating genomic DNA from buccal cells, may be used to isolate DNA from the cheek swab. These kits are commercially available and usually generate 0.5-2 micrograms of total DNA. Desirable genomic regions containing polymorphic genetic markers (such as STRs and SNPs) of the isolated DNA are then amplified via PCR to generate micrograms, typically from 1 to 10 micrograms, of DNA. The amplified DNA may be sequenced so that verification steps described below may be performed. This amplified DNA is encapsulated into microparticles.

Optionally, the encapsulation of DNA may include a control DNA molecule of a known sequence that is included at the same amount as the isolated DNA. The control DNA may be used for testing to determine whether any of encapsulated DNA is released, such as via the in vitro method described above.

Alternatively, or optionally, the DNA may be partially or fully labeled with fluorophores, such as Alexa Fluor® dyes (Molecular Probes, Inc.). The labeled DNA may be used to confirm that the DNA was successfully encapsulated, such as with flow cytometry of the encapsulated particles. Alternatively or additionally, the labeled DNA may be used to determine whether any of the encapsulated DNA will be released following delivery to an individual's skin. This test may be performed by measuring the fluorescence of the aqueous solution, buffer, or supernatant in which empty microparticles or those encapsulating labeled DNA were tested for DNA release in an in vitro method, such as described above.

Transmission electron microscopy (TEM) may be used to verify encapsulation of the amplified DNA.

In some embodiments, genomic DNA, mitochondrial DNA, and/or RNA is isolated from the sample using methods known in the art, such as those described in Sambrook et al (cited above). The concentration and integrity of the extracted DNA or RNA may be determined, for example, to inform the decis o proceed with PCR or reverse transcription or to obtain another sample.

In some embodiments, the DNA may be generated by PCR. For example, DNA comprising STRs may be amplified by PCR using primers that amplify three to five tetranucleotide repeat segments of the genomic DNA sample, optionally incorporating a detectable label, such as a radioactive or fluorescent label, as is known in the art. PCR primers for amplifying the DNA may be obtained from a commercial source or may be synthesized using methods known in the art. Software for design of PCR primers is well known in the art.

Examples of preferred STRs that may be amplified by PCR are set forth in Table 2 below. The skilled artisan will appreciate that additional suitable tetranucleotide and pentanucleotide repeats may also be amplified. One of the preferred qualities of suitable tetranucleotide DNA repeats is high heterozygosity (variability between individuals) in the subject population. Another preferred quality of suitable tetranucleotide DNA repeats is that they do not encode a biologically active product, for example, a protein, tRNA, rRNA, miRNA, or siRNA. A further preferred quality of suitable tetranucleotide DNA repeats is that they do not induce an immune response and produce no therapeutic action in the recipient.

The resulting PCR products are typically analyzed, for example, by electrophoresis, for the successful generation of tetranucleotide repeats and to confirm that the sample shows relatively unique representation of a DNA sample from an individual.

IV. Verification of Amplified DNA

In some embodiments, the DNA is analyzed to confirm that the DNA was obtained or generated from the desired source organism. For example, for DNA comprising STRs, the pattern of PCR products in the DNA may be compared to a control sample obtained from the source organism. The DNA may also be analyzed by DNA sequencing, for example cDNA sequencing or whole genome sequencing, to confirm that the DNA is from the desired source organism.

The sequencing of the DNA may be performed using methods known in the art. These include, but are not limited to basic sequencing methods, such as Sanger's method, Maxam-Gilbert sequencing and chain termination methods (Franca et al., Quarterly Review of Biophysics, 35(2):169-200, 2002), advanced methods and de novo sequencing, such as shotgun sequencing and bridge PCR (Braslavky et al., Proc. Natl. Acad. Sci, 100(7):3960-3964, 2003), or next-generation methods. Next-generation sequencing applies to genome sequencing, genome resequencing, transcriptome profiling (RNA-Seq), DNA-protein interactions (ChIP-sequencing), and epigenome characterization (de Magalhäes et al., Ageing Res Rev. 9(3)315-323, 2010; Liu et al., Journal of Biomedicine and Biotechnology, 2012;1-11, article ID 251364, 2012; and Hall, The Journal of Experimental Biology, 209:1518-1525, 2007). Resequencing is necessary, because the genome of a single individual of a species will not indicate all of the genome variations among other individuals of the same species.

Next Generation sequencing encompasses a number of methods, including, but not limited to single-molecule real-time sequencing, massively parallel signature sequencing, (MPSS), Polony sequencing, 454 pyrosequencing, ion torrent semiconductor sequencing, DNA nanoball sequencing, heliscope single molecule sequencing, sequencing by ligation (SOLID sequencing) and single molecule real time sequencing (SNRT). These methods are detailed and compared in Liu et al., Journal of Biomedicine and Biotechnology, 2012:1-11, article ID 251364, 2012, and Hall, The Journal of Experimental Biology, 209:1518-1525, 2007.

In some embodiments, the DNA is analyzed before it is combined with the paint. In other embodiments, the DNA is analyzed after it is combined with the paint.

The DNA may be purified to obtain pharmaceutical/biologics grade DNA suitably free of contaminants.

V. Methods of Making the Compositions

The microparticles may be made using a variety of known micrencapsulation methods, such as solvent evaporation, multi-walled (or double walled) microencapsulation, coacervation, and melt processing.

Any of the non-erodible polymers discussed above may be used to form the polymeric microparticles. In certain embodiments, the polymer is a hydrophobic polymer.

Solvents

Solvents that may be used in forming the rnicroparticles include organic solvents such as methylene chloride, which leave low levels of residue that are generally accepted as safe. Suitable water-insoluble solvents include methylene chloride, chloroform, dicholorethane, ethyl acetate and cyclohexane. Additional solvents include, but are not limited to, alcohols such as methanol (methyl alcohol), ethanol, (ethyl alcohol), 1-propanol (n-propyl alcohol), 2-propanol (isopropyl alcohol), 1-butanol (n-butyl alcohol), 2-butanol (sec-butyl alcohol), 2-methyl-1-propanol (isobutyl alcohol), 2-methyl-2-propanol (t-butyl alcohol), 1-pentanol (n-pentyl alcohol), 3-methyl-1-butanol (isopentyl alcohol), 2,2-dimethyl-1-propanol (neopentyl alcohol), cyclopentanol (cyclopentyl alcohol), 1-hexanol (n-hexanol), cyclohexanol (cyclohexyl alcohol), 1-heptanol (n-heptyl alcohol), 1-octanol (n-octyl alcohol), 1-nonanol (n-nonyl alcohol), 1-decanol (n-decyl alcohol), 2-propen-1-ol (allyl alcohol), phenylmethanol (benzyl alcohol), diphenylmethanol (diphenylcarbinol), triphenylmethanol (triphenylcarbinol), glycerin, phenol, 2-methoxyethanol, 2-ethoxyethanol, 3-ethoxy-1,2-propanediol, Di(ethylene glycol)methyl ether, 1,2-propanediol, 1,3-propanediol, 1,3-butanediol, 2,3-butanediol, 1,4-butanediol, 1,2-pentanediol, 1,3-pentanediol, 1,4-pentanediol, 1,5-pentanedial, 2,3-pentanediol, 2,4-pentanediol, 2,5-pentanediol, 3,4-pentanedial, 3,5-pentanediol, and combinations thereof. A preferred alcohol is isopropanol.

Materials that may be used to formulate a coacervate system comprise anionic, cationic, amphoteric, and non-ionic surfactants. Anionic surfactants include di-(2 ethylhexyl)sodium sulfosuccinate; non-ionic surfactants include the fatty acids and the esters thereof; surfactants in the amphoteric group include (1) substances classified as simple, conjugated and derived proteins such as the albumins, gelatins, and glycoproteins, and (2) substances contained within the phospholipid classification, for example lecithin. The amine salts and the quaternary ammonium salts within the cationic group also comprise useful surfactants. Other surfactant compounds useful to form coacervates include polysaccharides and their derivatives, the mucopolysaccharides and the polysorbates and their derivatives. Synthetic polymers that may be used as surfactants include compositions such as polyethylene glycol and polypropylene glycol. Further examples of suitable compounds that may be utilized to prepare coacervate systems include glycoproteins, glycolipids, galactose, gelatins, modified fluid gelatins and galacturonic acid.

2. Surfactants

Hydrophobic surfactants such as fatty acids and cholesterol may be added during preparation of the microparticles to improve the resulting distribution of hydrophobic encapsulated material in hydrophobic polymeric microparticles. Examples of suitable fatty acids include butyric acid, valeric acid, caproic acid, enanthic acid, caprylic acid, pelargonic acid, caprylic acid, undecylic acid, lauric acid, tridecylic acid, myristic acid, pentadecylic acid, palmitic acid, heptadecylic acid, stearic acid, nonadecanoic acid, arachic acid, isocrotonic acid, undecylenic acid, oleic acid, elaidic acid, sorbic acid, linoleic acid, linolenic acid and arachidonic acid.

Hydrophilic surfactants such as TWEEN® 20 and polyvinyl alcohol (PVA) improve distribution of hydrophilic dye in the polymers. Amphiphilic surfactants are preferred if the dye is hydrophilic and the polymer is hydrophobic.

Surfactant such as a fatty acid or a pharmacologically acceptable salt thereof is typically added in a ratio of from 0.2 to 1 part by weight of the fatty acid or salt thereof to 1 part by weight of the dye.

3 Micronizing and Nanoparticle Formation

Methods for micronizing the additional substance (e.g. DNA) for production of nanoparticles, if needed, include, for example, sonication and/or production of shear forces, and rotor stator mixing or miffing with a concentric shaft, at a speed between, for example, 5,000 RPM and 25,000 RPM.

In some embodiments, the DNA may be prepared by precipitation using standard techniques, such as ethanol or isopropanol precipitation, or salt precipitation. In some embodiments, the DNA is micronized by precipitation with calcium phosphate, and the precipitate is not dissolved but instead incorporated directly as nanoparticles into the microparticle. In some embodiments, the DNA is encapsulated as an emulsion in water which is later removed after the encapsulation process to produce a small solid particle of DNA. The DNA may also be bound to a solid nanoparticle such as silicon dioxide or gold, or crosslinked together to form aggregates.

Methods of encapsulating DNA in nanoparticles are described in the art. See, for example, US 2009/0311295, and van de Berg et al., 2010, Journal of Controlled Release 141: 234-240.

4. Distribution of Nanoparticles within Microparticles

Preferably the nanoparticles containing the additional substance (e.g. DNA) are uniformly distributed within the polymer microparticle and at a low loading level to avoid any leaching of the encapsulated additional substance.

The problem with most methods of manufacture of micro particles is that while the nanoparticles are dispersed initially following addition to polymer solution, the nanoparticles rapidly settle towards the bottom. Then when solvent is removed, the nanoparticles are present more preferentially in one part of the polymer than another. It is difficult to keep the nanoparticles dispersed while at the same time removing the polymer solvent to form the microparticles. Therefore, methods have been developed wherein the nanoparticles are dispersed in the polymer solution so that the solution is “stabilized” so that the nanoparticles stay uniformly distributed within the polymer for a period of time sufficient to form the microparticles. This time may be as short as ten minutes or as long as a few hours. The amount of time that the nanoparticle will remain suspended in the polymer depends on the size and composition of the nanoparticle.

Stability is a function of the selection of the polymer, the solvent composition as well as the method of dispersion and the density of the encapsulated material. For example, the concentration of the organic polymeric solution must be adjusted to keep the nanoparticles dispersed and prevent settling of the nanoparticles during the process of encapsulation. In a method theoretically (if not mechanistically) analogous to beating egg whites, the polymer solution is sonicated or otherwise subjected to shear forces, using an open blade mixer or rotor stator at 5000-25,000 RPM, or milled using a concentric shaft, until stable. Alternatively or in addition, the solvent and surfactant, if present, can be used to alter the surface properties of the nanoparticles so that they remain suspended in the polymer solution. The solvent is then removed to form the microparticles having a uniform dispersion of nanoparticles within the polymer.

Methods of Making Microparticles

There are several processes whereby microparticles can be made, including, for example, multi-walled microencapsulation, hot melt encapsulation, phase separation encapsulation, spontaneous emulsion, solvent evaporation microencapsulation, solvent removal microencapsulation, and coacervation. These methods are known in the art. Detailed descriptions of the methods are discussed in Mathiowitz et al.,“Microencapsulation”, in Encyclopedia of Controlled Drug Delivery, vol. 2, pp. 495-546, 1999, John Wiley & Sons, Inc. New York, N.Y., and are concisely presented below. A preferred method is solvent evaporation microencapsulation (specifically high oil to aqueous phase ratio to achieve small particles with addition of surfactant such as oleic acid to improve dispersion of the personalized fragment in the polymeric phase phase). For solvent evaporation, the minimum concentration is 0.1% w/v (polyvinyl alcohol to water). Another preferred method includes addition of the nanoparticles into the polymer liquefied by melting to ensure uniform distribution.

The dispersion of the nanoparticles within the polymer matrix can be enhanced by varying; (1) the solvent or combination of solvents used to solvate the polymer; (2) the ratio of the polymer to the solvent; (3) the size of the nanoparticle to be encapsulated; and (4) the percentage of the nanoparticle relative to the polymer (i.e. nanoparticle loading). The dispersion of the nanoparticles within the polymer matrix may also be enhanced by using surfactants.

In certain embodiments, the DNA is analyzed during the process of preparing the microparticles, e.g. after micronization and/or after encapsulation, to confirm the identity of the DNA. Generally, the microparticles are prepared in small batches.

A. Hot Melt Microencapsulation

In hot melt microencapsulation, the material (optionally in the form of nanoparticles) to be encapsulated is added to molten polymer. This mixture is suspended as molten droplets in a nonsolvent for the polymer (often oil-based) which has been heated to approximately 10° C. above the melting point of the polymer. The emulsion is maintained through vigorous stirring while the nonsolvent bath is quickly cooled below the glass transition of the polymer, causing the molten droplets to solidify and entrap the core material.

B. Phase Separation Microencapsulation

In phase separation microencapsulation the material (optionally in the form of nanoparticles) to be encapsulated is dispersed in a polymer solution with stirring. While continually stirring to uniformly suspend the material, a nonsolvent for the polymer is slowly added to the solution to decrease the polymer's solubility. Depending on the solubility of the polymer in the solvent and nonsolvent, the polymer either precipitates or phase separates into a polymer rich and a polymer poor phase. Under proper conditions, the polymer in the polymer rich phase will migrate to the interface with the continuous phase, encapsulating the DNA and/or fluorescent compound in a droplet with an outer polymer shell.

C. Spontaneous Emulsification

Spontaneous emulsification involves solidifying emulsified liquid polymer droplets by changing temperature, evaporating solvent, or adding chemical cross-linking agents. The physical and chemical properties of the encapsulant, and the material to be encapsulated, dictates the suitable methods of encapsulation. Factors such as hydrophobicity, molecular weight, chemical stability, and thermal stability affect encapsulation.

D. Melt-Solvent Evaporation Method

In the melt-solvent evaporation method, the polymer is heated to a point of sufficient fluidity to allow ease of manipulation (for example, stirring with a spatula). The temperature required to do this is dependent on the intrinsic properties of the polymer. For example, for crystalline polymers, the temperature will be above the melting point of the polymer. After reaching the desired temperature, the material to be encapsulated is added to the molten polymer and physically mixed while maintaining the temperature. The molten polymer and the material to be encapsulated are mixed until the mixture reaches the maximum level of homogeneity for that particular system. The mixture is allowed to cool to room temperature and harden. This technique results in dispersion of the DNA and/or fluorescent compound in the polymer.

High shear turbines may be used to stir the dispersion, complemented by gradual addition of the nanoparticle into the polymer solution until the desired loading is achieved. Alternatively the density of the polymer solution may be adjusted to prevent settling of the nanoparticle during stirring.

E. Solvent Evaporation Microencapsulation

In solvent evaporation microencapsulation, the polymer is typically dissolved in a water immiscible organic solvent and the material (optionally in the form of nanoparticles) to be encapsulated is added to the polymer solution as a dispersion, suspension or emulsion in an organic solvent. An emulsion (i.e. a second emulsion if the encapsulating material is added as an emulsion) is formed by adding this dispersion, suspension or emulsion to a beaker and vigorously stirring the system. Any suitable surface active agent may be used to stabilize the emulsion. Typical surface active agents include, but are not limited to polyethylene glycol or polyvinyl alcohol (PVA)). The organic solvent is evaporated while continuing to stir. Evaporation results in precipitation of the polymer, forming solid microcapsules containing core encapsulated material, where the encapsulated material is in the form of an emulsion or a solid.

The solvent evaporation process can be used to entrap a liquid core material in a polymer or in copolymer microcapsules, however the liquid is removed by conventional methods after the polymer has encapsulated the substance.

The solvent evaporation process is the preferred process for encapsulating DNA.

F. Solvent Removal Microencapsulation

In solvent removal microencapsulation, the polymer is typically dissolved in an oil miscible organic solvent and the material (optionally in the form of nanoparticles) to be encapsulated is added to the polymer solution as a suspension or solution in organic solvent. Surface active agents can be added to improve the dispersion of the material to be encapsulated. An emulsion is formed by adding this suspension or solution to vigorously stirring oil, in which the oil is a nonsolvent for the polymer and the polymer/solvent solution is immiscible in the oil. The organic solvent is removed by diffusion into the oil phase while continuing to stir. Solvent removal results in precipitation of the polymer, forming solid microcapsules containing core material.

G. Coacervation

Encapsulation procedures for various substances using coacervation techniques have been described in the art, for example, in GB-B-929 406; GB-B-929 401; U.S. Pat. Nos. 3,266,987: 4,794,000 and 4,460,563. Coacervation is a process involving separation of colloidal solutions into two or more immiscible liquid layers (Ref. Dowben, R. General Physiology, Harper & Row, New York, 1969, pp. 142-143.). Through the process of coacervation, compositions comprised of two or more phases known as coacervates may be produced. The ingredients that comprise the two phase coacervate system are present in both phases: however, the colloid rich phase has a greater concentration of the components than the colloid poor phase.

In the coacervation process, the polymer or copolymer is dissolved in a miscible mixture of solvent and nonsolvent, at a nonsolvent concentration which is immediately below the concentration which would produce phase separation (i.e., cloud point). The liquid core material is added to the solution while agitating to form an emulsion and disperse the material as droplets. Solvent and nonsolvent are vaporized, with the solvent being vaporized at a faster rate, causing the polymer or copolymer to phase separate and migrate towards the surface of the core material droplets. This phase-separated solution is then transferred into an agitated volume of nonsolvent, causing any remaining dissolved polymer or copolymer to precipitate and extracting any residual solvent from the formed membrane. The result is a microcapsule composed of polymer or copolymer shell with a core of liquid material,

For example, DNA may be dissolved in water and then an emulsion of the dissolved DNA is formed in an organic polymeric solution. This emulsion is then added to aqueous solution and mixed (optionally, for DNA having lengths of less than 2 kilobases (kb) high shear may be used) until the organic solvent evaporates, and then the entire mixture is washed and frozen and lyophilized, resulting in a dry particle of DNA inside the polymer.

The material can be encapsulated using an emulsifier such as Tween 80®, oleic acid, lecithin, Brij® 92, Span® 80, Arlacel® 83, and Span® 85. Alternatively, the material can be encapsulated without the use of an emulsifier.

H. Multi-Walled Microencapsulation

Multiwall polymer microspheres may be prepared by dissolving two polymers in a solvent. A material (e.g. DNA) to be incorporated is dispersed in the polymer solution, and the mixture is suspended in a continuous phase. The solvent then is slowly evaporated, creating microspheres with an inner core formed by one polymer and an outer layer of the second polymer. The continuous phase can be either an organic oil, a volatile organic solvent, or an aqueous solution containing a third polymer that is not soluble with the first mixture of polymers and which will cause phase separation of the first two polymers as the mixture is stirred.

Any two or more different non-biodegradable, hydrophobic polymers which are not soluble in each other at a particular concentration as dictated by their phase diagrams may be used. The multilayer microcapsules have uniformly dimensioned layers of polymer and can incorporate a range of substances.

For the preparation of double walled microspheres, each polymer is dissolved in a suitable solvent for that polymer, in separate containers, and mixed with surfactant such as oleic acid; the DNA and/or fluorescent compound, optionally in the form of nanoparticles, is added to one of the polymeric solutions. Then the two (or more) polymeric solutions are mixed, and the mixture is then added to a large volume aqueous phase containing a surfactant, such as PVA, to form an emulsion (aqueous solution of water and some surfactant). High shear is applied. The oil to water phase ratio is typically 1:20 to ensure small microparticle sizes in the range of 1-5 microns, or even smaller microparticles, such as in the range of 1 to 2 microns.

Microspheres containing a polymeric core made of a first polymer and a uniform coating of a second polymer, and a substance incorporated into at least one of the polymers, can be made as described in U.S. Pat. No. 4,861,627.

I. Solvent Evaporation

Solvent evaporation microencapsulation can result in the stabilization of the nanoparticle in a polymeric solution for a period of time sufficient for encapsulation of the nanoparticle. In certain embodiments, the nanoparticle is stabilized in the polymeric solution for about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 minutes. In certain embodiments, the nanoparticle is stabilized in the polymeric solution for at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 minutes. In certain embodiments, the nanoparticle is stabilized in the polymeric solution for less than about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 minutes. Any of these values may be used to define a range for the amount of time that the nanoparticle is stabilized in the polymeric solution.

For example, the nanoparticle may be stabilized in the polymeric solution for about 10 minutes to about 30 minutes.

Stabilizing a material to be encapsulated (e.g. DNA) within the dispersed phase (typically a volatile organic solvent) can be useful for most methods of microencapsulation that are dependent on a dispersed phase, including film casting, solvent evaporation, solvent removal, spray drying, phase inversion, and many others.

By stabilizing suspended nanoparticles within the dispersed phase, the nanoparticles remain homogeneously dispersed throughout the polymeric solution as well as the resulting polymer matrix that forms during the process of microencapsulation.

Solvent evaporation microencapsulation has several advantages. For example, solvent evaporation microencapsulation allows for the determination of the best polymer-solvent-nanoparticle mixture that will aid in the formation of a homogeneous suspension that can be used to encapsulate the nanoparticle. Solvent evaporation microencapsulation stabilizes the nanoparticles within the polymeric solution. This stabilization of nanoparticles is an advantage during small scale operation because one will be able to let suspensions of insoluble particles sit for short periods of time, making the process more secure and avoiding mixing between clients. Solvent evaporation microencapsulation allows for the creation of microparticles that have no release of the encapsulated material. Solvent evaporation microencapsulation avoids the problem of “burst effect”, i.e. release of the encapsulated material within 1 hour, which occurs with other encapsulation methods by allowing very low loading of the encapsulated material and creating microparticles that have minimal pores.

In some embodiments, the compositions are made in small batches. The size of the batches may be limited by the nature and the amount of the additional substance (e.g. DNA), or by the number of end users.

In preferred embodiments, the additional substance (e.g. DNA) and/or fluorescent compound is encapsulated into polymeric microparticles for personal use by one or few individuals. It is preferred, therefore, to prepare small batches of polymeric microparticles encapsulating the additional substance (e.g. DNA) and/or fluorescent compound. In some embodiments, the prepared batch size may be as small as for single use by a single individual. In other embodiments, the prepared batch size may be as small as for single use by few, such as no more than two, no more than three, no more than four, no more than five, no more than six, no more than seven, no more than eight, no more than nine, or no more than ten individuals. In other embodiments, the batch size may be as small as for multiple uses by the same individual.

In other embodiments, the size of a small batch preparation may be guided by the amount of the available DNA. For example, the amount of DNA obtained from one individual through a cheek swab may only be enough to produce a batch for single use by a single recipient. In a preferred embodiment, a single small batch yields a sufficient amount of microparticles for a single use by one end user.

In preferred embodiments, a small batch preparation process yields approximately 1-10g of microparticles encapsulating the additional substance (e.g. DNA) and/or fluorescent compound, in dry form, preferably about 1-2 g of microparticles encapsulating the DNA and/or fluorescent compound, in dry form. For example, in some embodiments, 0.1, 0. 2, 0.3, 0.4, 0.5, 0.6, 0.7, 0.8, 0.9, 1.0, 1.5, 2.0, 2.5, 3.0, 3.5, 4.0, 4.5, 5.0, 6.0, 7.0, 8.0, 9,0 or 10 grams of the microparticle is prepared. In some embodiments, less than 0.1, 0. 2, 0.3, 0.4, 0.5, 0.6, 0.7, 0.8, 0.9, 1.0, 1.5, 2.0, 2.5, 3.0, 3.5, 4.0, 4.5, 5.0, 6.0, 7.0, 8.0, 9.0 or 10 grams of the microparticle is prepared. Any of these values may be used to define a range of amounts in which the microparticle is prepared. For example, from 0.5 to 5 grams, or from 2 to 5 grams of the microparticle may be prepared. In a particular embodiment, approximately 2 grams of the microparticles is prepared.

In certain embodiments, the microencapsulated material is formulated in a dry powder form suitable for mixing with a paint by the artist. In some embodiments, the microencapsulated material may be mixed with a paint and supplied as a pre-dispersed solution. The paint used in combination with the microencapsulated material may be of any desired color known in the art.

In some embodiments, a paint comprising the additional substance (e.g. DNA) and/or a fluorescent compound may be prepared by mixing microparticles with paint. The microparticles and paint may be mixed by shaking, stirring, vortexing, or light sonicating of the microparticles with the paint. In some embodiments, the concentration of the rnicroparticles in the mixture of microparticles and paint is 0.001%, 0.005%, 0.01%, 0.55%, 0.1% 0.5%, 1%, 2%, 3%, 4%, 5%, 6%, 7%, 8%, 9% or 10% w/w.

Once the microparticles that contain the additional substance (e.g. DNA) and/or fluorescent compound are suspended within the paint, the paint may be applied to a surface, for example by pouring a small amount (for example, less than 10 grams) of the paint into a cup or other receptacle that is of sufficient size for one to dip a brush into the cup or receptacle. A painting may be created by dipping the brush into the cup or receptacle that contains the paint, and then applying the paint to a surface. In other embodiments, the paint may be applied to the surface with a roller or a spray gun. Suitable surfaces include, for example, a canvas, a wall, paper, wood, papyrus, plastics, vellum, leather and fabric.

VI. Kits

Kits for obtaining DNA from an end user and kits for preparing the painting comprising the DNA are provided. In some embodiments, a cheek swab kit is provided to a customer. The customer uses the cheek swab to obtain a sample from the human or non-human animal of interest to the customer. Then the customer mails or otherwise delivers the sample to a lab. The lab isolates, amplifies (if needed), and purifies (if needed) the DNA and then encapsulates the DNA, optionally in combination with a fluorescent compound, in microparticles. Then the encapsulated DNA is lyophilized into a powder. The powder is mixed with a paint. Then the paint is delivered to the customer. The customer then prepares a painting with the paint, or delivers the paint to an artist for preparation of the painting.

In another embodiment, a collection kit is provided to a customer. The customer places in the collection vessel (e.g. a vial) a sample from a source of interest to the customer. Then the customer mails or otherwise delivers the sample to a lab. The lab extracts

DNA from the sample, and then encapsulates the DNA, optionally in combination with a fluorescent compound in microparticles. Then the encapsulated material is lyophilized into a powder. The powder is added to a paint. Then the paint is delivered to the customer. The customer then prepares a painting comprising DNA with the paint, or delivers the paint to an artist for preparing of the painting comprising DNA.

In some embodiments, the kits provide the equipment for obtaining a sample of the DNA. For example, the kit may include a foam or cotton-tipped cheek swab, a protective container for the swab, and instructions for use.

In some embodiments, the kits provide the final product for use by the end user, i.e. one or more paints comprising the DNA and optionally the fluorescent compound. In other embodiments, the kits contain the DNA in a powder form, the fluorescent compound, and one or more paints for mixing with the DNA and the fluorescent compound.

The kits may be delivered to the end user, Alternatively, the kits may be delivered to an artist who uses the kit components to prepare the painting containing DNA,

### EXAMPLES

Materials

Medical grade PMMA (Mw=35 kDa; residual MMA monomer<0.1%) was purchased from Vista Optics Ltd. (Widnes, UK), PVA (Mw=25 kDa; 88% hydrolyzed) was purchased from Polysciences, Inc. (Warrington, Pa., USA). dichloromethane (DCM; Burdick and Jackson, Muskegon, Mich., USA), ethyl acetate (EA; Mallinckrodt, Hazelwood, Mo., USA), and 1-octanol (Sigma-Aldrich, St. Louis, Mo., USA) were analytical grade solvents. Particles were made by solvent evaporation microencapsulation.

### Example 1

### Preparation of Blank Poly (Methyl Methacrylate) (PMMA) Microparticles.

Materials and Methods

500 mg of PMMA (about 25,000 MW) was weighed in a 20-ml glass scintillation vial; 15 ml of dichloromethane (DCM) was added to PMMA, vortexed for 30 seconds and sonicated for 5 minutes until solution became clear (1). At this point, the polymer was completely dissolved and there was no particulate matter.

250 ml of surfactant, 1.0% polyvinyl alcohol) (PVA) (MW≈25,000 Da; 88% hydrolyzed) was poured into a 1-L Virtis® flask (2).

100 ml of 0.5% PVA (MW≈25,000 Da; 88% hydrolyzed) was poured into an 800 ml beaker (3). The beaker was placed under impeller (approximately 0.5 cm from bottom of beaker) with a speed set at 3,000 RPM.

Virtis® Cyclone was set to “55” (13,750 RPM); then 100 microliters of 1-octanol was added to the 1.0% PVA solution (2) and allowed to sit for 5 minutes (4). The PMMA solution (1) was added to (4) in the 1-L Virtis® flask. This mixture was mixed on the Cyclone for 15 minutes at 13,750 rpm.

The content was poured from the Virtis® flask into the 800 ml beaker containing 0.5% PVA (3) and stirred for about 24 hours to form a slurry of particles.

The slurry of particles was poured into 50 ml Eppendorf® tubes, the caps were screwed on and centrifuged for 20 minutes at 4,000 RPM (3345×g). PVA solution was aspirated off using a 50 ml pipette tip; this solution was kept for further evaluation. 40 ml of distilled water was added to tubes; mixed and shaken well until particles were resuspended in distilled water. The caps were screwed back on and centrifuged for an additional 20 minutes at 4,500 RPM. Distilled water was aspirated off using a 50 ml pipette tip, 40 ml distilled water was added to the tubes, mixed and shaken well until particles resuspended in distilled water. The caps were screwed back on and centrifuged for an additional 20 minutes at 4,000 RPM (3345×g), Distilled water was aspirated off using a 50 ml pipette tip. The slurry of particles was combined into one or two tubes, flash frozen and lyophilized for 48-72 hours.

Variation: The steps recited above were repeated with a different mass of PMMA (about 1M MW). The only difference occurred in the formation of the PMMA solution.

In the variation of Example 1, 500 mg of PMMA was weighed (about 1M MW) in a 50-ml Falcon tube; 30 ml of dichloromethane (DCM) was added to PMMA, vortexed (30 seconds) and sonicated (5 minutes) until the solution became clear.

Results

About 80% of PMMA used in this method formed blank PMMA microparticles.

Substantially the same yield was obtained in the variation of Example 1.

### Example 2

### Preparation of Poly (Methyl Methacrylate) (PMMA) Microparticles Containing Low Loading of DNA

Materials and Methods 1000 mg of PMMA (25,000 MW) was weighed in a 40-ml glass scintillation vial (1). DNA amplified at a mitochondrial locus was prepared. DNA was extracted from harvested human buccal mucosal cells by boiling for 10 minutes in the presence of 10% Chelex resin. A portion of the extracted DNA was PCR amplified using the following primers specific to a noncoding region of the human mitochondrial genome (bases 15,971-16411):

(SEQ ID NO: 1)
5′-TTAACTCCACCATTAGCACC-3′
(SEQ ID NO: 2)
5′-GAGGATGGTGGTCAAGGGAC-3′

The PCR product was purified using the Invitrogen PureLink Quick Gel Extraction & PCR Purification Combo kit. A portion of the purified DNA was labeled with AlexaFluor 488, ethanol precipitated to remove excess label, resuspended in water, and mixed with the remaining DNA to produce a solution suitable for encapsulation containing 5.6 nanograms of DNA per microliter. The DNA was dissolved in water, and the concentration of the solution was 5 micrograms per mL (2). About 100 microliters of DNA solution, corresponding to 0.56 microgram, was taken for microparticle preparation.

30 ml of dichloromethane (DCM) was added to the PMMA vial (1). 10 microliters of Span® 80 (sorbitan monooleate) was added to the PMMA solution and bath sonicated for 15 minutes (3). DNA (2) was pipetted into the PMMA solution (3) and mixed at 10,000 rpm for 1 minute to form an emulsion (4).

250 ml of surfactant, 1.0% PVA (MW≈25,000 Da; 88% hydrolyzed), was poured into a Virtis® flask. Virtis® Cyclone was set to 10000 RPM. 250 microliters of 1-octanol was added to the 1% PVA, mixed for 1 minute and then let to set for 5 minutes (5).

The PMMA-DNA emulsion (4) was added into the 1.0% PVA solution (5) and mixed for 15 minutes at 7,000 rpm (6).

200 ml of 0.5% PVA (MW≈25,000 Da; 88% hydrolyzed) was poured into an 800 ml beaker. The beaker was placed under impeller (approximately 0.5 cm from bottom of beaker) and the impeller speed was set at 3,000 RPM.

The contents from Virtis® flask (6) were poured into the 800ml beaker containing 0.5% PVA and stirred for approximately 24 hours to form a slurry of particles.

The slurry of particles was poured into 50 ml Eppendorf® tubes, the caps were screwed on and centrifuged for 20 minutes at 4,000 RPM (3345×g). The PVA solution was aspirated off using a 50 ml pipette tip. This solution was kept for further evaluation. 40 ml of distilled water was added to tubes; mixed and shaken well, until particles resuspended in distilled water. Sonication was used, as needed, to break up any particle aggregates stuck to the bottom of the tubes. The caps were screwed back on and centrifuged for an additional 20 minutes at 4,500 RPM. Distilled water was aspirated off using a 50 ml pipette tip. 40 ml distilled water was added to tubes, mixed and shaken well, until particles resuspended in distilled water. The caps were screwed back on and centrifuged for an additional 20 minutes at 4,000 RPM (3345×g). The distilled water was aspirated off using a 50 ml pipette tip. The slurry of particles was combined into one or two tubes, flash frozen and lyophilized for 48-72 hours.

Results

About 60% of PMMA used in this method formed PMMA microparticles with low amounts of DNA.

The morphology of the particles was observed using scanning electron microscopy (SEM). In general, the particles were spherical in shape and had a smooth surface morphology. No pores were visible, even at high magnification (4,000×). The microspheres generally had a particle diameter of 1-2 micrometers. No fragments of polymer or DNA were observed in the micrographs. Observation of these microparticles under a fluorescent microscope revealed that a portion of them contained DNA labeled with AlexaFluor 488.

We claim:

1. A method of preparing a painting comprising a substance encapsulated in a non-erodible, polymeric microparticle, the method comprising applying paint comprising the encapsulated substance to a surface, wherein the microparticle comprises a hydrophobic, non-erodible polymer, and wherein the encapsulated substance is selected from the group consisting of a nucleic acid, sand, soil, metal cremated ash, ceramics, and plant tissue.

2. The method of claim 1, wherein the microparticle does not release the substance.

3. The method of claim 1, wherein the polymer is selected from the group consisting of polyvinyl acetate, polyacrylate, polymethacrylate, and copolymers and blends thereof.

4. The method of claim 1, wherein the microparticle comprises less than 0.01% (w/w) of the substance.

5. The method of claim 1, wherein the microparticle comprises at least 10% (w/w) of the substance.

6. The method of claim 1, wherein the microparticle has a size ranging from 1 micron to 1000 microns.

7. The method of claim 1, wherein the substance is DNA.

8. The method of claim 7, wherein the DNA comprises a personal identification characteristic selected from the group consisting of short tandem repeats (STRs), single nucleotide polymorphisms (SNPs), epigenetic markers, and methylated DNA patterns.

9. The method of claim 7, wherein the DNA is human DNA.

10. The method of claim 7, wherein the DNA is comprised within a particle that is at least 1 mm in diameter.

11. The method of claim 1, wherein the painting comprises an image of a human,

12. The method of claim 1, wherein the painting comprises at least two different colors of paint.

13. The method of claim 1, wherein the paint is selected from the group consisting of latex paint, oil paint, synthetic paint, and watercolor paint.

14. The method of claim 7, wherein the DNA is isolated from an organism,

15. A method of preparing a painting comprising an image that is visible under fluorescent light and comprises an additional substance, the method comprising applying paint comprising at least one fluorescent compound and the additional substance to a surface to form the image, wherein the additional substance is selected from the group consisting of a nucleic acid, sand, soil, metal, cremated ash, ceramics, and plant tissue.

16. The method of claim 15, wherein the painting further comprises an image that is not visible under fluorescent light and does not comprise the additional substance.

17. The method of claim 15, wherein the DNA is fluorescently labeled.

18. The method of claim 15, wherein the fluorescent compound is a fluorescent bead.

19. The method of claim 15, wherein the fluorescent compound is encapsulated in a non-erodible, polymeric microparticle, wherein the microparticle comprises a hydrophobic, non-erodible polymer.

20. The method of claim 19, wherein the microparticle does not release the fluorescent compound.


SEQUENCE LISTING (2 sequences)

SEQ ID NO: 1 - DNA, 20 bp, Artificial Sequence
  primer
ttaactccaccattagcacc

SEQ ID NO: 2 - DNA, 20 bp, Artificial Sequence
  primer
gaggatggtggtcaagggac